(19) United States
(12) Patent Application Publication
(10) Pub. No.: US 2004/0130807 A1
(43) Pub. Date: Jul. 8, 2004

(54) Optical unit

(75) Inventors: Hiroyuki Hattori, Tokyo (JP); Yuichi Atarashi, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/740,610

(22) Filed: Dec. 22, 2003

(30) Foreign Application Priority Data
Dec. 25, 2002 (JP) JP2002-374260

(51) Int. Cl. G02B 7/02

(52) U.S. Cl. 359/811

(57) ABSTRACT

An optical unit having therein integrated plural optical elements each having a flange portion, wherein at least one of the optical elements has three or more projections on at least one surface of the flange portion and the projections are brought into contact with a flange portion of another optical element, and are fixed.

### BACKGROUND OF THE INVENTION

The present invention relates to an optical unit wherein a plurality of optical elements are united integrally.

There has been an optical unit wherein optical elements each having a flange portion are integrated in a way that their flange portions are stuck to each other and fixed (for example, JP-A No. 2002-269794).

When constituting an optical unit by integrating two or more optical elements as stated above, it is necessary to integrate them accurately so that an occurrence of a tilt may be controlled.

In the case of an objective lens for optical pickup, for example, there sometimes are occasions where an occurrence of coma caused by an occurrence of a tilt makes it impossible to achieve a lens performance.

However, when integrating through adhesion and fixing of flange portions of optical elements as stated above, if a distortion is caused even if on a single portion of the flange portion, the position of the adhesion and fixing is deviated, resulting in the situation of an occurrence of a tilt.

Recently, in particular, an objective lens is required to be accurate by a high density recording method employing a laser beam with wavelength of 405 nm, which makes it necessary to integrate optical elements with further less tilt.

For manufacturing the entire flange portion without distortion, it is necessary to manufacture it by machining a metal mold that molds a lens so that positional relationship with the entire areas including optical functional surfaces and surfaces of flange portions may be accurate, which requires extremely high-grade technologies.

In the conventional optical unit, a space between a first optical element and a second optical element is made airtight, because a flange portion of the first optical element and that of the second optical element adhere to each other and are fixed to each other. When this space is made airtight, if working environmental temperature and humidity for the optical unit are changed, there sometimes are occasions where moisture contained in the space is saturated to cause condensation of dew drops on optical functional surfaces to adversely affect optical performances.

### SUMMARY OF THE INVENTION

The invention has been achieved in view of the problems mentioned above, and its object is to provide an optical unit wherein an occurrence of a tilt is easily controlled and an occurrence of condensation of dew drops is further controlled.

The aforementioned object of the invention has been attained by either one of the following Structures (1)-(3).

Structure (1): An optical unit having therein integrated plural optical elements each having a flange portion, wherein at least one of the optical elements has three or more projections on at least one surface of the flange portion and the projections are brought into contact with the flange portion of another optical element, and are fixed.

Structure (2): An optical unit having therein a correcting element having a flange portion and a glass mold lens having a flange portion, both integrated each other, wherein a surface of the flange portion of the correcting element has thereon three or more projections, and the projections are brought into contact with the flange portion of the glass mold, and are fixed.

Structure (3): An optical unit having therein a correcting element having a flange portion, a first plastic lens having a flange portion and a second plastic lens having a flange portion wherein three or more projections are provided on a surface on one side of the flange portion of the correcting element, three or more projections are provided on a surface on one side of the flange portion of the first plastic lens, projections on the flange portion of the correcting element are brought into contact with the surface having thereon no projections of the flange portion of the first plastic lens to be fixed, and projections on the flange portion of the first plastic lens are brought into contact with the flange portion of the second plastic lens, to be fixed.

### BRIEF DESCRIPTION OF THE DRAWINGS

FIG. 1(a) is a front view showing an example of an optical unit of the invention and FIG. 1(b) is a sectional view showing an example of an optical unit of the invention.

FIGS. 2(a) and 2(b) are diagrams for illustrating how to manufacture an optical unit of the invention.

FIG. 3(a) is a front view showing an example of an optical unit of the invention and FIG. 3(b) is a sectional view showing an example of an optical unit of the invention.

FIGS. 4(a)-4(d) are diagrams for illustrating how to manufacture an optical unit of the invention.

### DETAILED DESCRIPTION OF THE PREFERRED EMBODIMENT

Embodiments of the invention will be explained as follows referring to the drawings, to which, however, the invention is not limited. Further, in the following explanation, there are some conclusive presentations for terminology, but they show preferable examples, and they limit neither meanings of terminology nor technical scope, of the invention.

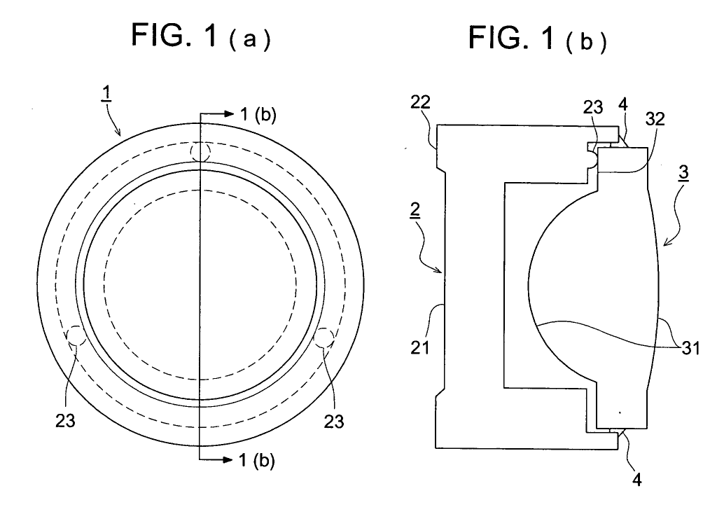

FIG. 1(a) is a front view of an example of the optical unit of the invention, and FIG. 1(b) is a sectional view taken on line 1(b)-1(b) in FIG. 1(a).

Optical unit 1 shown in FIGS. 1(a) and 1(b) is composed of diffracting plate 2 which is an optical element relating to the invention and is a correcting element conducting correction of chromatic aberration on the diffracting surface and of glass mold lens 3 representing an optical element relating to the invention. The diffracting plate 2 has thereon optical functional surface 21 and flange portion 22, and the glass mold lens 3 also has thereon optical functional surface 31 and flange portion 32. Further, the diffracting plate 2 has three projections 23 on a surface of the flange portion 22, the surface being in contact with flange portion 32 of glass mold lens 3. The diffracting plate 2 is made of plastic.

The diffracting plate 2 and glass mold 3 are fixed by adhesives 4 under the state wherein three projections 23 on the flange portion 22 of the diffracting plate 2 are in contact with the surface of the flange portion 32 of the glass mold 3. However, adhesives are not applied on the entire circumference but are applied on prescribed areas, for preventing condensation of dew drops.

Though the flange portions are fixed through adhesion by the use of adhesives in the present embodiment, they may also be fixed through fitting or deposition, in addition to the aforementioned adhesives.

Preferable adhesives 4 include plastic adhesives of, for example, a denaturated epoxy resin type or a denaturated acrylate resin type and resins of a UV curing type.

In the optical unit 1 shown in FIGS. 1(a) and 1(b), the diffracting plate 2 is formed so that a tilt may be controlled under the state where three projections 23 are in contact with the surface of flange portion 32 of glass mold lens 3. In the conventional optical unit, it has been necessary to prepare a metal mold wherein adjustment is made accurately about the positional relationship between the optical functional surface and the entire area of the surface of the flange portion, because it has been necessary to prevent an occurrence of a tilt under the state where surfaces of the flange portions of the optical elements are in contact each other. In the optical unit of the invention, at least one of optical units comes in contact with a flange portion of another optical element with only projections, and therefore, with respect to the optical element, if a metal mold wherein adjustment is made accurately for only the positional relationship between the optical functional surface and a vertex of the projection representing a portion to contact a flange portion of another optical element, is prepared, it is possible to form an optical element wherein an occurrence of a tilt is controlled. It is therefore possible to obtain a highly accurate optical unit in which an occurrence of a tilt can be controlled more easily than in the past.

Further, in the optical unit 1 shown in FIGS. 1(a) and 1(b), ventilation characteristics between the diffracting plate 2 and glass mold lens 3 are secured, because projections 23 of the diffracting plate 2 are made to be in contact with the surface of the flange portion 32 of the glass mold lens 3.

The optical unit of the invention is of the structure wherein, when a plurality of optical elements are integrated as stated above, at least one of the optical elements has, on its flange portion, three or more projections, and these projections are brought into contact with a flange portion of another optical element to be fixed. Therefore, it is possible, in manufacture of a metal mold stated above, to obtain a highly accurate optical unit wherein an occurrence of a tilt is controlled by easy work such as adjustment of only positional relationship between an optical functional surface and a vertex of the projection, thus, productivity of optical units can be improved.

In the optical unit of the invention, optical elements are made to be in contact with each other through projections to be integrated, and therefore, a space between optical elements is not made airtight and condensation of dew drops is not caused on optical functional surfaces accordingly, thus, optical performances are not affected adversely.

In the invention, projections in quantity of three or more are made to be in contact with a flange portion of another optical element so that they may be fixed, and thereby, effects of the invention can be obtained, in which three projections are most preferable. By making three projections to be the lowest required number, adjustment turns out to be more easy, and productivity can further be improved.

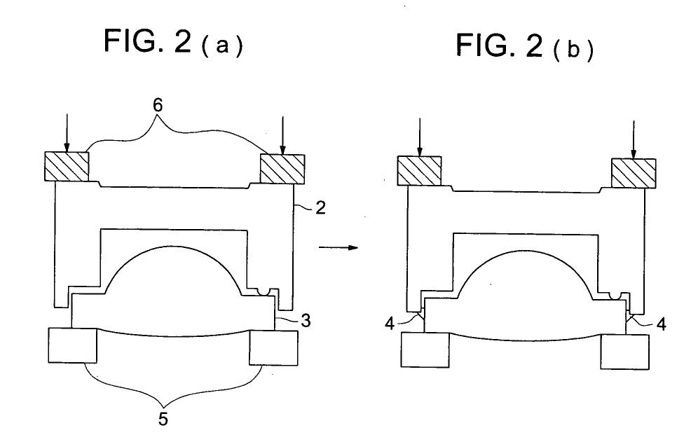

Next, how to assemble the optical unit shown in FIGS. 1(a) and 1(b) will be explained by referring to FIGS. 2(a) and 2(b).

The diffracting plate 2 to be used is represented by one that is molded by a metal mold wherein adjustment is accurately made about positional relationship between optical functional surface 21 and a vertex of projection 23 so that no tilt may be caused under the condition that all three projections 23 of the diffracting plate 2 are in contact with flange portion 32 of glass mold lens 3.

As shown in FIGS. 2(a) and 2(b), glass mold lens 3 is placed on pedestal 5 so that optical functional surfaces 31 of the glass mold lens 3 do not touch anything, and then, diffracting plate 2 is pressed against the glass mold lens 3 in the direction of an arrow after being adjusted so that no shift of an optical axis may be generated, to cause the state wherein all three projections 23 of the diffracting plate 2 are in contact with flange portion 32 of the glass mold lens 3 (FIG. 2(a)).

In this case, if elastic member 6 such as rubber is placed on a portion of flange portion 22 other than the optical functional surface 21 of the diffracting plate 2 for pressing in the direction of an arrow so that force may be applied evenly on the diffracting plate 2, three projections 23 come into contact with flange portion 32 of the glass mold lens 3 uniformly because three projections 23 of the diffracting plate 2 resist the force evenly, which is preferable.

After achieving the state wherein all three projections 23 of the diffracting plate 2 are in contact with flange portion 32 of the glass mold lens 3, adhesives 4 are applied on portions shown in FIGS. 2(a) and 2(b) and are dried. When the adhesives 4 are UV curing resins, the resins are irradiated with ultraviolet rays to be hardened (FIG. 2(b)). Adhesives 4 are not applied entirely on the flange portion 22 and flange portion 32, but are applied on several points at regular intervals to be fixed, which is preferable. Due to this, a space between optical elements is not made airtight and an occurrence of condensation of dew drops can be controlled.

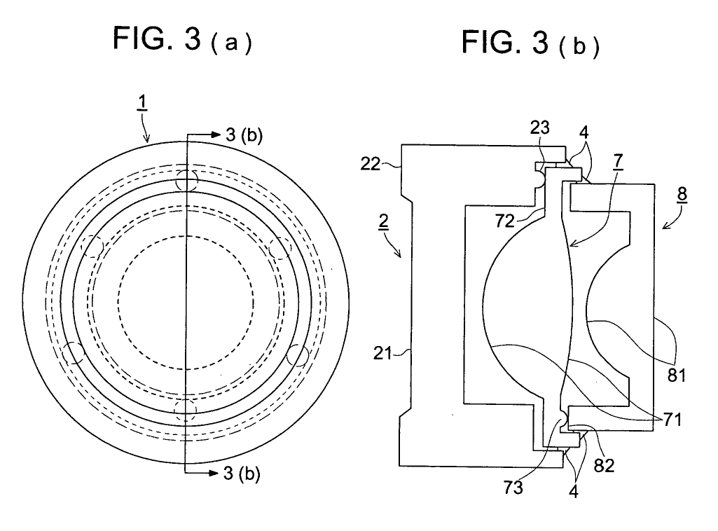

Further, positions to be applied with adhesives 4 may either be those shown in FIGS. 3(a) and 3(b), or the adhesives may be applied on tips of three projections 23 in advance, to be fixed under the condition that the projections 23 are made to touch flange portion 32 of glass mold lens 3 when the diffracting plate 2 is pressed against the glass mold lens 3. In this case, it is naturally necessary to press the diffracting plate 2 against the glass mold lens 3 firmly to harden the adhesives, to avoid that a tilt is caused by existence of adhesives 4 between projections 23 and flange portion 32.

FIG. 3(a) is a front view of another optical unit of the invention, and FIG. 3(b) is a sectional view taken on line 3(b)-3(b) in FIG. 3(a).

Incidentally, in the explanation of the drawings hereafter, an explanation of those having the same symbols as those explained in the explanation for the drawings stated above and an explanation relating thereto are sometimes omitted, but, unless otherwise specified, these explanations are the same as those for the drawings mentioned above.

Optical unit 1 shown in FIGS. 3(a) and 3(b) is composed of diffracting plate 2 that is an optical element relating to the invention and is a correcting element that corrects chromatic aberration on a diffracting surface and of plastic lenses 7 and 8 each representing an optical element relating to the invention. The plastic lens 7 has optical functional surface 71 and flange portion 72, and the plastic lens 8 also has optical functional surface 81 and flange portion 82. Further, the flange portion 72 of the plastic lens 7 has three projections 73 on its surface touching flange portion 82 of the plastic lens 8. The diffracting plate 2 and the plastic lenses 7 and 8 are made of plastic.

The diffracting plate 2 and the plastic lens 7 are stuck to each other with adhesives 4 under the state that three projections 23 of flange portion 22 are in contact with the surface of the flange portion 72 having no projections 73. In addition, the plastic lens 7 and the plastic lens 8 are stuck to each other with adhesives 4 under the state that three projections 73 of flange portion 72 are in contact with the surface of the flange portion 82.

In the optical unit 1 shown in FIGS. 3(a) and 3(b), the diffracting plate 2 is formed in a way that a tilt is controlled under the state where three projections 23 are in contact with the surface of flange portion 72. Further, the plastic lens 7 is formed in a way that a tilt is controlled under the state where three projections 73 are in contact with the surface of flange portion 82.

Further, in the optical unit shown in FIGS. 3(a) and 3(b), ventilation characteristics between the diffracting plate 2 and plastic lens 7 are secured, because projections 23 of the diffracting plate 2 are made to be in contact with the surface of the flange portion 72. In addition, ventilation characteristics between the plastic lens 7 and the plastic lens 8 are also secured, because projections 73 of the plastic lens 7 are made to be in contact with the surface of the flange portion 82.

Optical unit 1 shown in FIGS. 3(a) and 3(b) is an optical unit wherein a tilt is caused more easily than integrating two optical elements because three optical elements (one piece of correcting element and two pieces of plastic lenses) are integrated, but it is possible, in manufacture of a metal mold stated above, to control an occurrence of a tilt with easy work such as adjustment of only positional relationship between the optical functional surface and a vertex of a projection, and to improve productivity of optical units, because of the structure wherein the surface on one side in each of contact surfaces of flange portions of optical elements is made to touch as three projections, to be fixed with adhesives.

In the optical unit 1 shown in FIGS. 3(a) and 3(b) again, flange portions are made to be in contact each other through projections to be integrated, and therefore, a space between optical elements is not made airtight and condensation of dew drops is not caused on optical functional surfaces accordingly, thus, optical performances are not affected adversely.

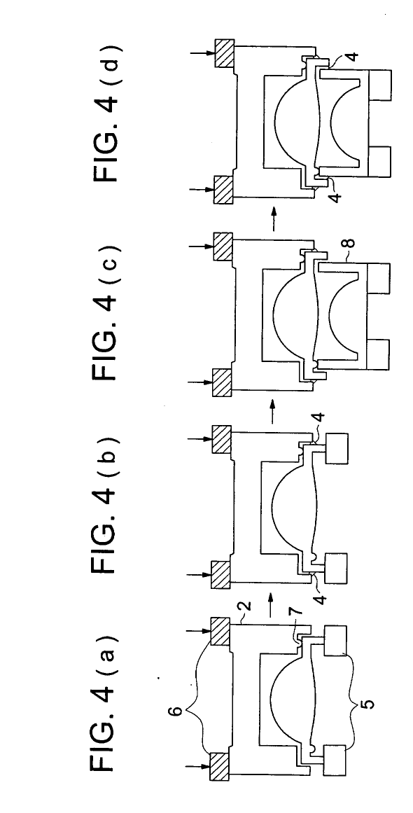

Next, how to assemble the optical unit shown in FIGS. 3(a) and 3(b) will be explained by referring to FIGS. 4(a)-4(d).

The diffracting plate 2 to be used is represented by one that is molded by a metal mold wherein adjustment is accurately made about positional relationship between optical functional surface 21 and a vertex of projection 23 so that no tilt may be caused under the condition that all three projections 23 of the diffracting plate 2 are in contact with flange portion 72 of plastic lens 7. Further, the plastic lens 7 to be used is represented by one that is molded by a metal mold wherein adjustment is accurately made about positional relationship between optical functional surface 71 and a vertex of projection 73 so that no tilt may be caused under the condition that all three projections 73 of the plastic lens 7 are in contact with flange portion 82 of plastic lens 8.

As shown in FIGS. 4(a)-4(d), plastic lens 7 is placed on pedestal 5 so that optical functional surfaces 71 of the plastic lens 7 do not touch anything, and then, diffracting plate 2 is pressed against the plastic lens 7 in the direction of an arrow after being adjusted so that no shift of an optical axis may be generated, to cause the state wherein all three projections 23 are in contact with flange portion 72 (FIG. 4(a)).

In this case, if elastic member 6 such as rubber is placed on a portion of flange portion 22 other than the optical functional surface 21 of the diffracting plate 2 for pressing in the direction of an arrow so that force may be applied evenly on the diffracting plate 2, three projections 23 come into contact with flange portion 72 uniformly because three projections 23 of the diffracting plate 2 resist the force evenly, which is preferable.

After achieving the state wherein all three projections 23 of the diffracting plate 2 are in contact with flange portion 72, adhesives 4 are applied on portions shown in FIGS. 4(a) to 4(d) and are dried or hardened through irradiation of ultraviolet rays (FIG. 4(b)).

Next, plastic lens 8 is placed on pedestal 5 so that optical functional surfaces 81 of the plastic lens 8 do not touch anything, and then, plastic lens 7 combined with diffracting plate 2 is pressed against the plastic lens 8 in the direction of an arrow after being adjusted so that no shift of an optical axis may be generated, to cause the state wherein all three projections 73 are in contact with flange portion 82 (FIG. 4(c)).

Equally in this case, if elastic member 6 such as rubber is placed on a portion of flange portion 22 other than the optical functional surface 21 of the diffracting plate 2 for pressing in the direction of an arrow, three projections 73 of the plastic lens 7 come into contact with flange portion 82 uniformly because three projections 73 of the plastic lens 7 resist the force evenly, which is preferable.

After all three projections 73 have come into contact with flange portion 82, adhesives 4 are applied on the portions shown in FIGS. 4(a) to 4(d) to be dried or hardened through irradiation of ultraviolet rays (FIG. 4(d)).

The invention made it possible to provide an optical unit wherein an occurrence of a tilt can be controlled easily and an occurrence of condensation of dew drops can further be controlled.

What is claimed is:

1. An optical unit comprising:
(a) at least one of a plurality of optical elements each having a flange portion, including three or more projections on at least one surface of the flange portion; and
(b) an optical element other than at least one of the plurality of optical elements,
wherein the projections are brought into contact with the flange portion of the optical element other than at least one of the plurality of optical elements, and are fixed to each other to be integrally formed as a unit.

2. An optical unit comprising:
(a) a correcting element having a flange portion, a surface of the flange portion having three or more projections; and
(b) a glass mold lens having a flange portion,
wherein the projections are brought into contact with the flange portion of the glass mold lens, and are fixed to each other to be integrally formed as a unit.

3. An optical unit comprising
(a) a correcting element having a flange portion, three or more projections being provided on a surface on one side of the flange portion of the correcting element;
(b) a first plastic lens having a flange portion, three or more projections being provided on a surface on one side of the flange portion of the first plastic lens; and
(c) a second plastic lens having a flange portion,
wherein the projections on the flange portion of the correcting element are brought into contact with a surface having no projections of the flange portion of the first plastic lens, to be fixed, and the projections on the flange portion of the first plastic lens are brought into contact with the flange portion of the second plastic lens, to be fixed, thereby the correcting element, the first plastic lens and the second plastic lens are integrally formed as a unit.

4. The optical unit of claim 1, wherein at least one of the optical elements having three or more projections on at least one surface of the flange portion and another optical element are fixed with a plastic adhesive of a denaturated epoxy resin type, a denaturated acrylate resin type, or resins of a UV curing type.

5. The optical unit of claim 2, wherein the correcting element and the glass mold lens are fixed with a plastic adhesive of a denaturated epoxy resin type, a denaturated acrylate resin type, or resins of a UV curing type.

6. The optical unit of claim 3, wherein the correcting element, the first plastic lens and the second plastic lens are fixed with a plastic adhesive of a denaturated epoxy resin type, a denaturated acrylate resin type, or resins of a UV curing type.
